(19) United States
(12) Patent Application Publication
(10) Pub. No.: US 2011/0075735 A1
(43) Pub. Date: Mar. 31, 2011

(54) Advanced Video Coding Intra Prediction Scheme

(75) Inventor: David Drezner, Raanana (IL)

(73) Assignee: Broadcom Corporation, Irvine, CA (US)

(21) Appl. No.: 12/965,406

(22) Filed: Dec. 10, 2010

Related U.S. Application Data
(62) Division of application No. 11/148,555, filed on Jun. 9, 2005.
(60) Provisional application No. 60/578,065, filed on Jun. 9, 2004.

(51) Int. Cl. H04N 7/50

(52) U.S. Cl. 375/240.13; 375/E07.211

(57) ABSTRACT

A system and method are disclosed for efficiently determining a prediction block for a current block of interest in a video signal encoding protocol. In a preferred embodiment, this is achieved by determining whether there is a correlation between the intra 4×4 predictions and the 16×16 predictions. If the correlation to the 16×16 prediction modes is lower than a predetermined threshold value, then the additional prediction blocks using 16×16 intra luma prediction are not calculated. If the correlation to the 16×16 prediction modes is higher than the predetermined threshold value, then the additional prediction blocks are calculated using 16×16 intra luma prediction. A cost function may then be used to determine the predicted bit cost of each prediction block, and the prediction block with the lowest cost may be selected as the prediction block for the current block of interest.

### CROSS-REFERENCE TO RELATED APPLICATIONS

This application is a Divisional of U.S. application Ser. No. 11/148,555 filed on Jun. 9, 2005 by DREZNER, David, the entire contents of which is herein incorporated by reference and from which priority is claimed under 35 U.S.C §120. U.S. application Ser. No. 11/148,555 claims benefit to U.S. Provisional Application No. 60/578,065, filed on Jun. 9, 2004 entitled “ADVANCED VIDEO CODING INTRA PREDICTION SCHEME” which is incorporated by reference herein in its entirety.

### BACKGROUND OF THE INVENTION

1. Field of the Invention

The present invention relates generally to compression of digital video signals, and specifically to a system and method for an Advanced Video Coding intra prediction scheme. More specifically, the present invention relates to a system and method for determining whether or not to perform 16×16 intra luma prediction for a current block of interest.

2. Background Art

Digital video and video/audio products and services such as video telephone, teleconference, digital television systems and the like, and devices for storage and retrieval of video/audio streams on the Internet are ubiquitous in the marketplace. Due to limitations in digital signal storage capacity and limitations in network and broadcast bandwidth, compression of digital video signals is essential to digital video storage and transmission. As a result, many standards for compression and encoding of digital video and video/audio signals have been promulgated. These standards specify with particularity the form of encoded digital video signals and how such signals are to be decoded for presentation to a viewer.

Compression is made possible by virtue of a high degree of redundancy both within each image frame and between consecutive image frames of the video signal. In other words, one image frame may differ only slightly from the preceding image frame(s), or one portion of an image frame may differ only slightly from another portion of the same image frame. The redundancy allows certain portions of an image frame to be extrapolated or predicted based on the preceding image frames or the preceding portions within the same image frame. Consequently, the amount of information in the video signal that actually needs to be transmitted may be substantially reduced.

A number of encoding standards have been developed to help standardize the transmission of video and audio signals over low bandwidth media. One example of such a standard is ITU-T Recommendation H.264 and ISO Standard MPEG-4 Part 10, “Advanced Video Coding” (hereinafter “AVC”) which is designed to provide a visual coding standard for allowing content-based interactivity, improved coding efficiency and universal accessibility in such applications as low-bit rate communications, interactive multimedia (e.g. games, interactive TV and the like) and surveillance.

Under such standards, the high degree of content redundancy within an image frame and between consecutive image frames allows a block to be extrapolated or predicted based on the surrounding or neighboring blocks. More specifically, the redundancy allows for prediction of pixels or of DCT coefficients or other transform coefficients that are used in the encoding scheme to represent the color and luminance of the pixels in the blocks. The motion of the pixels may also be predicted based on this redundancy. In general, the larger the amount of information that can be used for prediction, the more accurate the prediction of the pixels in a block will be, and hence the residual prediction error will be smaller and cheaper to encode, resulting in higher compression ratio and higher quality of the transmitted video for a given bitrate constraint.

Intra coding refers to the case where only spatial redundancies within a video frame are exploited. INTRA coding may be used in any frame type (I, P, B frame) as an alternative to INTER coding. I-pictures are typically encoded (in the previous standards without INTRA prediction) by directly applying the transform to the different macroblocks in the frame. As a consequence, encoded I-pictures are large in size since a large amount of information is usually present in the frame.

If a macroblock is encoded in intra mode, a prediction block is formed based on previously encoded and reconstructed blocks (already coded macroblocks located on top and to the left of the current macroblock of interest). This prediction block P is subtracted from the current block of interest prior to encoding. For the luminance (luma) samples, P may be formed for each 4×4 sub-block or for a 16×16 macroblock. There are a total of nine optional prediction modes for each 4×4 luma block and four optional modes for a 16×16 luma block.

### 4×4 Intra Luma Prediction

Referring now to FIG. 1, there is shown a sample data block labeled A to M. The first six modes divide the 16×16 block to 16 4×4 sub-blocks. The pixels in each sub-block are labeled accordingly:
1) Lower-case letters are the pixels in the sub-block to be coded.
2) Upper-case letters are the pixels in the neighboring sub-blocks that have already been coded.

Referring now to FIG. 2, there is shown arrows which indicate the direction of prediction in each mode. For modes 3 to 8, the predicted samples are formed from a weighted average of the prediction samples A to M.

For example, if Mode 1 (horizontal prediction) is selected, then the values of the pixels “a” to “p” are assigned as follows:

a, b, c, d, are equal to I,

e, f, g, h, are equal to J,

j, k, 1, are equal to K,

m, n, o, and p are equal to L.

In the case where Mode 0 (Vertical prediction) is selected, then the values of the pixels “a” to “p” are assigned as follows:

a, b, c, d, are equal to A,

e, f, g, h, are equal to B,

I, j, k, 1, are equal to C,

m, n, o, and p are equal to D.

In the case where Mode 3 (Diagonal_Down_Left prediction) is chosen, the values of “a” to “p” are given as follows:

a is equal to (A+2B+C+2)/4,

b and e are equal to (B+2C+D+2)/4,

c, f and i are equal to (C+2D+E+2)/4,

d, g and j are equal to (D+2E+F+2)/4,

h, k and n are equal to (E+2F+G+2)/4,

l and o are equal to (F+2G+H+2)/4,

p is equal to (G+3H+2)/4.

After a prediction block P has been created by each of the nine prediction modes for a given 4×4 block, the magnitude of the prediction error is typically determined. For example, the Sum of Absolute Errors (SAE) may be used to indicate the magnitude of the prediction error for each prediction block P resulting from each prediction mode. The prediction block P which gives the smallest prediction error is determined to be the best match to the actual current block of interest.

### 16×16 Intra Luma Prediction

An alternative to the 4×4 luma prediction modes described above is the prediction of the entire 16×16 luma component of a macroblock. Four prediction modes (DC, Vertical Horizontal and Planar) are available with 16×16 intra coding. This alternative is preferably used for regions with less spatial detail (i.e. flat regions).

Calculating a prediction block for each mode (9 prediction modes for 4×4 and 4 modes for 16×16) for a given block of interest and determining the magnitude of the prediction error for each prediction block requires significant processing power and time. Therefore, what is need is a system and method that will determine more efficiently the best intra luma prediction mode to use to produce the best match for the current block of interest.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

The present invention comprises a system and method substantially as shown in and/or described in connection with at least one of the figures, as set forth more completely in the claims.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 illustrates a sample data block labeled A to M.

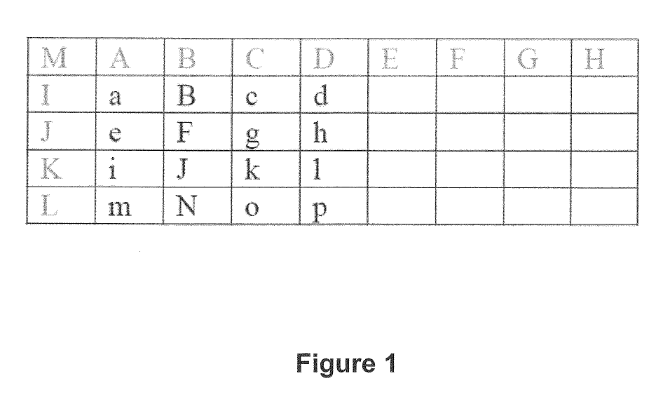

FIG. 2 illustrates the direction of the prediction modes for intra luma prediction.

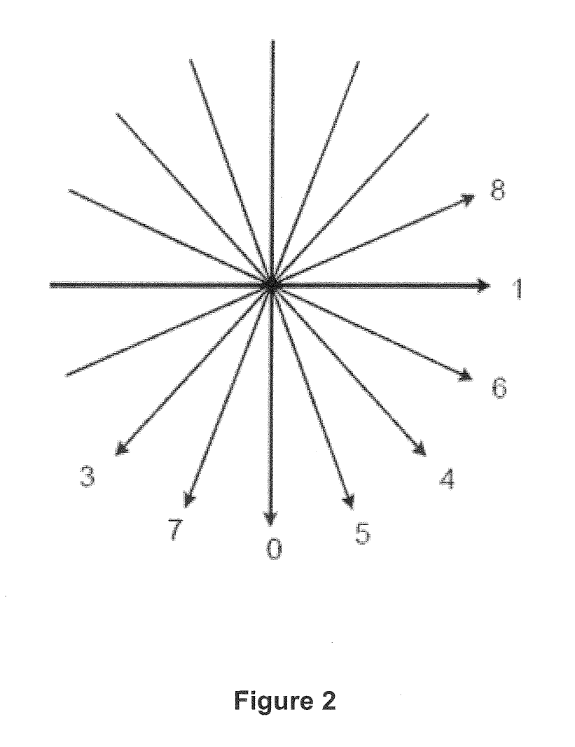

FIG. 3 is a flow chart illustrating the steps for determining a prediction block in accordance with one embodiment of the present invention.

FIG. 4 is a flow chart illustrating the steps for determining correlation between the 4×4 prediction directions and the 16×16 prediction modes in accordance with one embodiment of the present invention.

FIG. 5 is a block diagram illustrating a system in accordance with one embodiment of the present invention

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known processes and steps have not been described in detail in order not to unnecessarily obscure the present invention.

The invention generally pertains to predicting intra-coded blocks in a video signal encoding protocol, such as in an Advanced Video Coding (“AVC”) system. More particularly, the invention pertains to an improved system and method for determining a prediction block for a current block of interest. If there is a high correlation between the intra 4×4 prediction directions, most of them to horizontal, vertical or DC, then the present invention performs intra prediction of 16×16 and a cost function to determine if the 16×16 intra prediction should be used. If the cost of 16×16 intra prediction is less then all 4×4 intra prediction modes plus their overhead signaling mode costs, then the present invention can save mode overhead by changing all the selected 16×(intra prediction 4×4) to one 16×16 intra prediction mode (set16×16 mode to founded correlated direction). If the correlation to the 16×16 prediction modes is lower than the predetermined threshold value, then the additional prediction blocks using 16×16 intra luma prediction are not calculated.

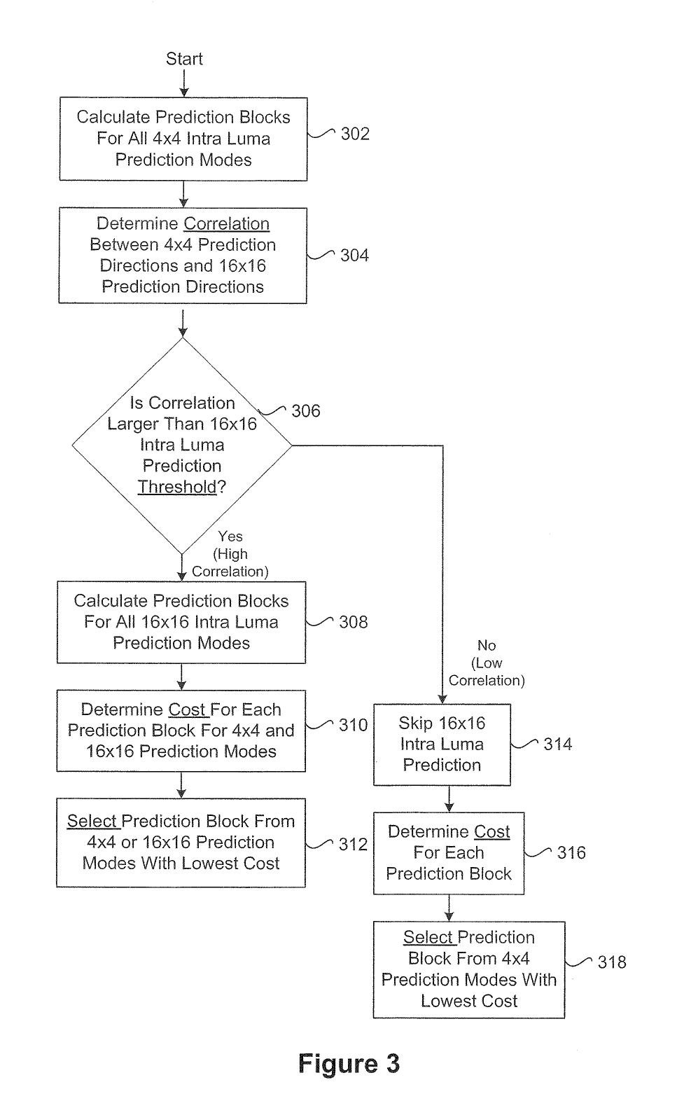

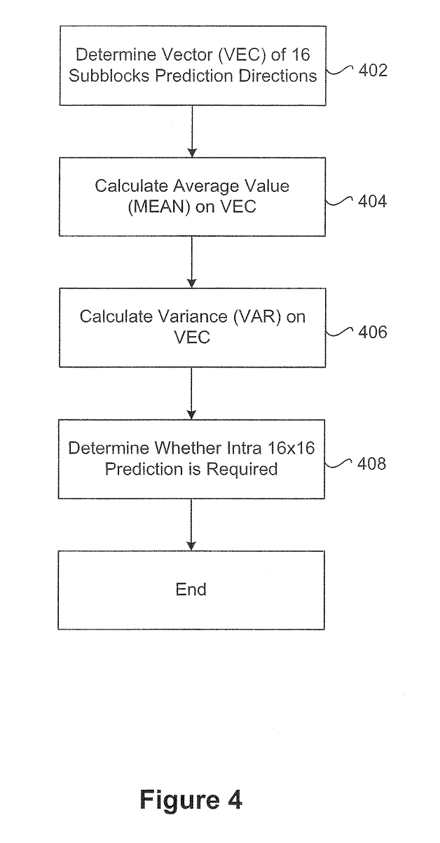

Referring now to FIG. 3, there is shown a flow chart illustrating the steps for determining a prediction block for a current block of interest in accordance with one embodiment of the present invention. First, prediction blocks for all 4×4 intra luma prediction modes are calculated at step 302. Then, at step 304, the correlation between the 4×4 prediction directions is calculated. The steps for calculating the correlation between the 4×4 prediction directions is described in more detail with reference to FIG. 4.

The correlation is then compared to a predetermined threshold value at step 306. If the correlation is larger than the predetermined threshold value, then there is considered to be a high correlation between the 4×4 intra prediction directions. If the correlation is equal to or lower than the predetermined threshold value, then there is considered to be a low correlation between the 4×4 intra prediction directions. One skilled in the art will realize that the present invention is not limited to this convention for determining whether the correlation is high or low but that any relation or reference to the predetermined threshold value may be used to determine a high or low correlation.

If there is a high correlation between the 4×4 intra luma prediction directions and the 16×16 prediction modes, then the prediction blocks for all 16×16 directions is calculated at step 308. At step 310, the cost for each 4×4 prediction block and for each 16×16 prediction block is then determined and analyzed. The 4×4 prediction block or 16×16 prediction block with the lowest cost is selected, at step 312, as the prediction block for the current block of interest.

If there is a low correlation between the 4×4 intra luma prediction directions, then the present invention skips, at step 314, the 16×16 intra luma predictions for the current block of interest. At step 316, the cost for each 4×4 prediction block is determined and analyzed, and the 4×4 prediction block with the lowest cost is selected, at step 318, as the prediction block for the current block of interest. Thus, the present invention improves efficiency by skipping the prediction process for 16×16 data blocks when the prediction process for 4×4 data blocks is not correlated in the 16×16 directions. The result is a method which saves processing power and time.

As will be appreciated by one skilled in the art, various methods may be used for calculating cost for the various prediction blocks. In one embodiment, cost (COST) may be calculated using the following equation:

ResidualSubBlock=CurrentSubBlock−PredictedIntraSubBlock

In another embodiment, VAR COST may be calculated to determine the cost of a given prediction block. In this embodiment, the SubBlockCost may be determined by calculating VAR in the same way as described above on each ResidualSubBlock of 4×4=total 16 pixels (VEC len=16). The macroblock cost (MB COST) may then be determined by calculating the sum of all SubBlockCost (total of 16 VAR) plus the direction overhead (if the direction is changing from subblock to subblock).

In yet another embodiment, the Weighted Sum of Absolute Transformed Differences cost (WSATD COST) may be used to calculate the cost of a given prediction block. In this embodiment, the well known Hadamart 4×4 transform may be performed on each ResidualSubBlock. The Wtransform is then determined by multiplying transform coefficients by cost matrix (dot by dot Multiply/Array multiply): TransformVal(I,J)×CostMatrix(I,J). The SubBlockCost is then determined by performing the sum of absolute WTransform coefficients, and the macroblock cost (MB COST) is determined by calculating the sum of all the SubBlockCost (total of 16 VAR) plus direction overhead (if the direction is changing from subblock to subblock).

In calculating the correlation between the 4×4 prediction directions, different known correlation methods may be applied. Referring now to FIG. 4, there is shown a flow chart illustrating the steps for determining correlation between the 4×4 prediction directions and the 16×16 prediction directions in accordance with one embodiment of the present invention. At step 402, the vector of the 16 subblocks prediction directions (VEC) is calculated. In one embodiment, a mapping function between the standard 4×4 directions and the intra prediction correlation of the present invention is used. Preferably, the mapping function is defined by the following: standard 4×4 intra direction 3→correlator of the present invention using 0 value: 7→1, 0→2, 5→3, 4→4, 6→5, 1→6, 8→7.

At step 404, the average value (MEAN) of VEC is then calculated. Thus,

MEAN=( 1/16)×ΣVEC(i).

Then the variance (VAR) of VEC is calculated at step 406. Thus,

VAR{E(X̂2)−E(X)̂2}=( 1/16)×Σ(VEC(i)̂2)−( 1/256)×(ΣVEC(i))̂2.

At step 408, the correlation values MEAN and VAR are then used to determine whether intra 16×16 prediction is needed. In accordance with one embodiment of the present invention, if the MEAN value is in the horizontal, vertical or DC direction, and VAR is lower than a predetermined threshold value, then 16×16 prediction in the MEAN direction is performed. If the MEAN value is not in the horizontal, vertical or DC direction or VAR is greater than a predetermined threshold value, then no 16×16 prediction is performed. In one embodiment, the predetermined threshold value is determined using a trial and error experimental process. In a preferred embodiment, the predetermined threshold value equals 2. Thus, the present invention improves efficiency and saves processing power by skipping the prediction process for 16×16 data blocks when the prediction process for 4×4 data blocks is not correlated in 16×16 directions.

In another embodiment, further performance cost savings may be achieved by using non reconstructed surrounded sub block coefficients in the 4×4 cost evaluation and correlation stage. First, the preferred direction of the intra coding mode must be determined. Then, the decision whether to use intra or inter coding mode (valid only in P, B frames) must be made. In the case when intra prediction is chosen, the reconstructed surrounding sub blocks for the coding is used. If inter coding mode is determined to have a lower macro block cost, then much of the reconstructed calculation is spared. In a preferred embodiment, reconstructed calculation refers to full coding of the 4×4 subblock, i.e. integer transform (4×4)→quantization→inverse quantization→inverse integer transform (4×4).

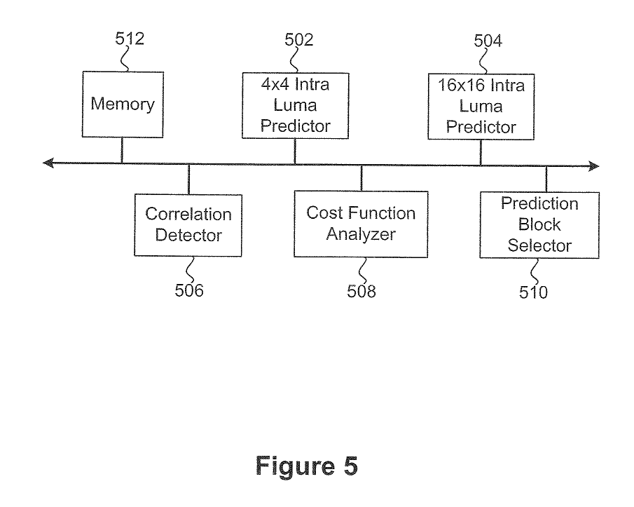

Referring now to FIG. 5, there is shown a block diagram of a system 500 for determining a prediction block for a current block of interest. In a preferred embodiment, system 500 may be implemented in a BCM7034 device, produced by Broadcom Corporation of Irvine, Calif., to implement its various functions. System 500 comprises a 4×4 intra luma predictor 502 for calculating 4×4 prediction blocks for the current block of interest, a 16×16 intra luma predictor 504 for calculating 16×16 prediction blocks for the current block of interest if required, a correlation detector 506 for determining the correlation between the 4×4 prediction directions and the 16×16 prediction directions and comparing the correlation to a predetermined threshold value, a cost function analyzer 508 for determining the cost for each of the calculated prediction blocks, and a prediction block selector 510 for selecting a prediction block based on the lowest cost. The system 500 also includes a memory 512 for storing block, macroblock, and prediction block information.

As already described above, system 500 calculates prediction blocks using 16×16 intra luma prediction only if the correlation between the 4×4 intra luma directions is high (i.e. greater than a predetermined threshold value). Prediction blocks using 16×16 intra luma prediction are not calculated if the correlation between the 4×4 intra luma directions is low (i.e. smaller than a predetermined threshold value).

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method for coding a prediction block for a current block of interest of picture data, the method comprising:
determining a direction of an intra-coding prediction mode using non-reconstructed sub-block coefficients;
determining whether to select an inter-coding prediction mode or an intra-coding prediction mode;
in response to selecting the intra-coding prediction mode, coding the prediction block using a plurality of reconstructed surrounding sub-blocks; and
in response to selecting the inter-coding prediction mode, coding the prediction block using a plurality of reconstructed inter-coded residual pixels.

2. The method of claim 1, wherein the determining whether to select an inter-coding prediction mode or an intra-coding prediction mode comprises determining based on cost.

3. The method of claim 1, wherein the determining whether to select an inter-coding prediction mode or an intra-coding prediction mode further comprises determining based on a weighted sum of absolute transformed differences cost.

4. The method of claim 1, wherein the determining whether to select an inter-coding prediction mode or an intra-coding prediction mode further comprises determining based on macro-block cost.

5. The method of claim 1, wherein the determining whether to select an inter-coding mode or an intra-coding mode further comprises determining based on a variance cost.

6. A system for coding a prediction block for a current block of interest of picture data, comprising:
an intra luma predictor configured to determine a direction of an intra-coding prediction mode using a plurality of non-reconstructed sub-block coefficients and to code the prediction block using a plurality of reconstructed surrounding sub-blocks;
an inter luma predictor configured to code a prediction block using a plurality of reconstructed inter-coded residual pixels;
a cost function analyzer configured to determine a cost for a prediction block; and
a prediction block selector configured to select the inter luma coding predictor or the intra luma coding predictor based on the cost determined by the cost function analyzer.

7. The system of claim 6, wherein the cost function analyzer is configured to determine the cost based on a weighted sum of absolute transformed differences cost.

8. The system of claim 6, wherein the cost function analyzer is configured to determine the cost based on a macro-block cost.

9. The system of claim 6, wherein the cost function analyzer is configured to determine the cost based on a variance cost.

10. A digital processing system comprising:
a processing circuit;
a memory coupled to the processing circuit; and
an apparatus coupled to the processing circuit and the memory, comprising:
an intra luma predictor configured to determine a direction of an intra-coding prediction mode of the picture data using a plurality of non-reconstructed sub-block coefficients and to code a prediction block using a plurality of reconstructed surrounding sub-blocks;
an inter luma predictor configured to code the prediction block using a plurality of reconstructed inter-coded residual pixels;
a cost function analyzer configured to determine a cost for the prediction block; and
a prediction block selector configured to select the inter luma coding predictor or the intra luma coding predictor based on the cost determined by the cost function analyzer.

11. A system, comprising:
a printed circuit board; and
an apparatus mounted on the printed circuit board, comprising:
an intra luma predictor configured to determine a direction of an intra-coding prediction mode of picture data using a plurality of non-reconstructed sub-block coefficients and to code a prediction block using a plurality of reconstructed surrounding sub-blocks;
an inter luma predictor configured to code the prediction block using a plurality of reconstructed inter-coded residual pixels;
a cost function analyzer configured to determine a cost for the prediction block; and
a prediction block selector configured to select the inter luma coding predictor or the intra luma coding predictor based on the cost determined by the cost function analyzer.

12. The system of claim 11 further comprising:
a memory mounted on the printed circuit board and coupled to the apparatus.

13. The system of claim 11 further comprising:
a processing circuit mounted on the printed circuit board and coupled to the apparatus.
